(19) United States
(12) Patent Application Publication
(10) Pub. No.: US 2022/0414847 A1
(43) Pub. Date: Dec. 29, 2022

(54) HIGH DYNAMIC RANGE IMAGE PROCESSING

(71) Applicant: QUALCOMM Incorporated, San Diego, CA (US)

(72) Inventors: Nyeongkyu KWON, San Diego, CA (US); Shang-Chih CHUANG, San Diego, CA (US); Ting-Kuei HU, San Diego, CA (US); Yi-Chun LU, San Diego, CA (US)

(21) Appl. No.: 17/362,667

(22) Filed: Jun. 29, 2021

(51) Int. Cl. G06T 5/00; G06T 5/50

(52) U.S. Cl. CPC G06T 5/007; G06T 5/002; G06T 5/50; G06T 2207/20208; G06T 2207/20221

(57) ABSTRACT

Systems and techniques are described for generating a high dynamic range (HDR) image. An imaging system can be configured to receive a first image captured by an image sensor according to a first exposure time. The imaging system can generate a modified image based on the first image by modifying the first image using a gain setting to simulate a second exposure time based on exposure compensation. The imaging system generates a high dynamic range (HDR) image at least in part by merging multiple images. The multiple images include a second-exposure image that corresponds to the second exposure time. The second-exposure image can be the modified image. The second-exposure image can be based on the modified image, processed variant of the modified image processed for noise reduction based on one or more other images actually captured using the second exposure time.

### FIELD

This application is related to image processing. More specifically, this application relates to systems and methods of performing high dynamic range (HDR) image processing by merging multiple image frames of a scene that each correspond to different exposures, with one of the images modified via exposure compensation to simulate a different exposure.

### BACKGROUND

The dynamic range of a digital imaging device, such as a digital camera, is the ratio between the largest amount of light that the device can capture without light saturation, and the lowest amount of light the device can accurately measure and distinguish from intrinsic image noise (electrical noise, thermal noise, etc.). Traditionally, digital cameras are able to capture only a small portion of the natural illumination range of a real-world scene. For example, the dynamic range of a scene may be, 100,000:1, while the dynamic range of the image sensor of a digital camera may be, 100:1. When the dynamic range of the scene exceeds the dynamic range of the sensor, details in the regions of highest light levels and/or lowest light levels are lost.

### BRIEF SUMMARY

In some examples, systems and techniques are described for generating a high dynamic range (HDR) image without ghosting artifacts. An imaging device can generate a high dynamic range (HDR) image by merging multiple images corresponding to different exposure settings. Some of the images can be captured at the different exposure settings that they correspond to. One of the images may be modified via exposure compensation to simulate a different exposure than the image was captured with. For example, an imaging system can be configured to receive a first image captured by an image sensor according to a first exposure time. The imaging system can generate a modified image based on the first image at least in part by modifying the first image using a gain setting. The gain setting is configured so that the first image is modified to simulate a second exposure time based on exposure compensation. In an illustrative example, the first exposure is a short exposure time, the second exposure time is a long exposure time, and the gain setting brightens the first image (that was captured with a short exposure time) so that the modified image appears similar to an image captured with the long exposure time. The imaging system generates a high dynamic range (HDR) image at least in part by merging multiple images. The multiple images include a second-exposure image that corresponds to the second exposure time. The second-exposure image can be the modified image. The second-exposure image can be based on the modified image, for instance being a processed variant of the modified image (e.g., with noise reduction processing based on one or more other images actually captured using the second exposure time).

In one example, an apparatus for image processing is provided. The apparatus includes a memory and one or more processors (e.g., implemented in circuitry) coupled to the memory. The one or more processors are configured to and can: receive a first image captured by an image sensor according to a first exposure time; generate a modified image based on the first image at least in part by modifying the first image using a gain setting, the gain setting being configured to simulate a second exposure time based on an exposure compensation; and generate a high dynamic range (HDR) image at least in part by merging a plurality of images, wherein the plurality of images includes a second image that corresponds to the second exposure time and that is based on at least the modified image.

In another example, a method of image processing is provided. The method includes: receiving a first image captured by an image sensor according to a first exposure time; generating a modified image based on the first image at least in part by modifying the first image using a gain setting, the gain setting being configured to simulate a second exposure time based on an exposure compensation; and generating a high dynamic range (HDR) image at least in part by merging a plurality of images, wherein the plurality of images includes a second image that corresponds to the second exposure time and that is based on at least the modified image.

In another example, a non-transitory computer-readable medium is provided that has stored thereon instructions that, when executed by one or more processors, cause the one or more processors to: receive a first image captured by an image sensor according to a first exposure time; generate a modified image based on the first image at least in part by modifying the first image using a gain setting, the gain setting being configured to simulate a second exposure time based on an exposure compensation; and generate a high dynamic range (HDR) image at least in part by merging a plurality of images, wherein the plurality of images includes a second image that corresponds to the second exposure time and that is based on at least the modified image.

In another example, an apparatus for image processing is provided. The apparatus includes: means for receiving a first image captured by an image sensor according to a first exposure time; means for generating a modified image based on the first image at least in part by modifying the first image using a gain setting, the gain setting being configured to simulate a second exposure time based on an exposure compensation; and means for generating a high dynamic range (HDR) image at least in part by merging a plurality of images, wherein the plurality of images includes a second image that corresponds to the second exposure time and that is based on at least the modified image.

In some aspects, the second image is the modified image.

In some aspects, the methods, apparatuses, and computer-readable medium described above further comprise: receiving a third image captured by the image sensor according to the second exposure time, wherein the second image is based on at least the modified image and the third image. In some aspects, the methods, apparatuses, and computer-readable medium described above further comprise: generating the second image at least in part by performing noise reduction on the modified image based on at least the third image.

In some aspects, the plurality of images includes the first image.

In some aspects, the methods, apparatuses, and computer-readable medium described above further comprise: receiving a third image captured by the image sensor according to the first exposure time, wherein the plurality of images includes a fourth image that corresponds to the first exposure time and that is based on at least the first image and the third image. In some aspects, the methods, apparatuses, and computer-readable medium described above further comprise: generating the fourth image at least in part by performing noise reduction using at least the first image and the third image.

In some aspects, the methods, apparatuses, and computer-readable medium described above further comprise: receiving a third image captured by the image sensor according to a third exposure time, wherein the plurality of images includes the third image.

In some aspects, the methods, apparatuses, and computer-readable medium described above further comprise: receiving a third image and a fourth image both captured by the image sensor according to a third exposure time, wherein the plurality of images includes a fifth image that corresponds to the third exposure time and that is based on at least the third image and the fourth image. In some aspects, the methods, apparatuses, and computer-readable medium described above further comprise: generating the fifth image at least in part by performing noise reduction using at least the third image and the fourth image. In some aspects, the third exposure time is shorter than the first exposure time and the second exposure time. In some aspects, the third exposure time is longer than the first exposure time and the second exposure time. In some aspects, the third exposure time is between than the first exposure time and the second exposure time.

In some aspects, the second exposure time is longer than the first exposure time. In some aspects, the second exposure time is shorter than the first exposure time.

In some aspects, the methods, apparatuses, and computer-readable medium described above further comprise: outputting the HDR image. In some aspects, the methods, apparatuses, and computer-readable medium described above further comprise: a display, wherein outputting the HDR image includes displaying the HDR image using the display. In some aspects, the methods, apparatuses, and computer-readable medium described above further comprise: a communication transceiver, wherein outputting the HDR image includes sending the HDR image to a recipient device using the communication transceiver.

In some aspects, the methods, apparatuses, and computer-readable medium described above further comprise: the image sensor.

In some aspects, the apparatus is, is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is a block diagram illustrating an example architecture of an image capture and processing system, in accordance with some examples;

FIG. 2 is a conceptual diagram illustrating multiple images of a scene having different exposures being merged into a high dynamic range (HDR) image of the scene, in accordance with some examples;

FIG. 3 is a conceptual diagram illustrating multiple images of a scene having different exposures being merged into a high dynamic range (HDR) image of the scene according to one or more fusion maps, in accordance with some examples;

FIG. 4A is a block diagram illustrating an example architecture of an imaging system that merges multiple images of a scene to generate a high dynamic range (HDR) image of a scene, in accordance with some examples;

FIG. 4B is a block diagram illustrating an example architecture of an imaging system that merges multiple images of a scene to generate a noise-reduced image of the scene, in accordance with some examples;

FIG. 5 is a conceptual diagram illustrating a high dynamic range (HDR) image depicting a person and including a ghost of an arm of the person, in accordance with some examples;

FIG. 6A is a table illustrating high dynamic range (HDR) fusion for different regions of a scene, with a HDR anchor having a short exposure and with highlights corresponding to short exposure, in accordance with some examples;

FIG. 6B is a table illustrating high dynamic range (HDR) fusion for different regions of a scene, with a HDR anchor having a long exposure and with highlights corresponding to short exposure, resulting in a conflict, in accordance with some examples;

FIG. 6C is a table illustrating high dynamic range (HDR) fusion for different regions of a scene, with a HDR anchor having a short exposure and with non-shadows corresponding to short exposure, in accordance with some examples;

FIG. 6D is a table illustrating high dynamic range (HDR) fusion for different regions of a scene, with a HDR anchor having a long exposure and with non-shadows corresponding to short exposure, resulting in a conflict, in accordance with some examples;

FIG. 7A is a block diagram illustrating example operations of an imaging system that merges multiple noise-reduced images of a scene to generate a high dynamic range (HDR) image of the scene, in accordance with some examples;

FIG. 7B is a block diagram illustrating example operations of an imaging system that merges multiple noise-reduced images of a scene to generate a high dynamic range (HDR) image of the scene, with one of the noise-reduced images being based on a modified image that simulates a different exposure via exposure compensation, in accordance with some examples;

FIG. 8A is a conceptual diagram illustrating a high dynamic range (HDR) image of a scene that includes ghosting visual artifacts along certain edges of moving objects, in accordance with some examples;

FIG. 8B is a conceptual diagram illustrating a high dynamic range (HDR) image of the scene of FIG. 8A that includes clear edges of moving objects without ghosting visual artifacts due to the use of a modified image in generating the HDR image, in accordance with some examples;

FIG. 9A is a conceptual diagram illustrating a high dynamic range (HDR) image of a scene generated using a small noise reduction (NR) noise threshold and a large HDR noise threshold, in accordance with some examples;

FIG. 9B is a conceptual diagram illustrating a high dynamic range (HDR) image of the scene of FIG. 9A generated using a large noise reduction (NR) noise threshold and a small HDR noise threshold, in accordance with some examples;

FIG. 10 is a flow diagram illustrating operations for image processing, in accordance with some examples; and

FIG. 11 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

The dynamic range of a digital imaging device, such as a digital camera, is the ratio between the largest amount of light that the device can capture without light saturation, and the lowest amount of light the device can accurately measure and distinguish from intrinsic image noise (electrical noise, thermal noise, etc.). Traditionally, digital cameras are able to capture only a small portion of the natural illumination range of a real-world scene. For example, the dynamic range of a scene may be, 100,000:1, while the dynamic range of the image sensor of a digital camera may be, 100:1. When the dynamic range of the scene exceeds the dynamic range of the sensor, details in the regions of highest light levels and/or lowest light levels are lost.

An imaging device can generate a high dynamic range (HDR) image by merging multiple images that captured with different exposure settings. For instance, an imaging device can generate a HDR image by merging together a short-exposure image captured with a short exposure time, a medium-exposure image captured with a medium exposure time that is longer than the short exposure time, and a long-exposure image captured with a long exposure time that is longer than the medium exposure time. Because short-exposure images are generally dark, they generally preserve the most detail in the highlights (bright areas) of a photographed scene. Medium-exposure images and the long-exposure images are generally brighter than short-exposure images, and thus may be overexposed (e.g., too bright to make out details in) in the highlights (bright areas) of the scene. Because long-exposure images are generally bright, they generally preserve the most detail in the shadows (dark areas) of a photographed scene. Medium-exposure images and the short-exposure images are generally darker than long-exposure images, and thus may be underexposed (e.g., too dark to make out details in) in the shadows (dark areas) of the scene, making their depictions of the shadows too dark to see details in. To generate an HDR image, the imaging device may, for example, use portions of the short-exposure image to depict highlights (bright areas) of the photographed scene, use portions of the long-exposure image depicting shadows (dark areas) of the scene, and use portions of the medium-exposure image depicting other areas (other than highlights and shadows) of a scene.

In some cases, one of the images merged to form the HDR image can be dominant in terms of determining how certain elements depicted in the HDR image appear. Such a dominant image can be referred to as an anchor. For instance, an object that is moving in a photographed scene, such as a moving vehicle driving along a road, may appear sharp in a short-exposure image captured with a short exposure time, but may appear blurry (e.g., due to motion blur) in a long-exposure captured with a long exposure time. If the short-exposure image is selected to be the anchor for the HDR image, the moving vehicle may appear sharp in the HDR image because the depiction of the moving vehicle in HDR image is most dominantly based on the depiction of the moving vehicle in the short-exposure image, rather than the depiction of the moving vehicle in the long-exposure image. If the long-exposure image is selected to be the anchor for the HDR image, the moving vehicle may appear blurry (e.g., due to motion blur) in the HDR image because the depiction of the moving vehicle in HDR image is most dominantly based on the depiction of the moving vehicle in the long-exposure image, rather than the depiction of the moving vehicle in the short-exposure image. Selection of the anchor can be performed manually by the user or can be performed automatically by the imaging device.

In some cases, visual artifacts, such as “ghosting,” may be produced in HDR images due to conflicts between which image the HDR image should draw from based on region brightness (e.g., highlights, shadows) and which image the HDR image should draw from based on region movement and anchor selection. For example, if the long-exposure image is selected to the anchor for an HDR image, and a region of the scene is both in motion and a highlight, then it can be unclear whether the long-exposure image should be used for that region (based on the anchor selection and motion of the region) or the short-exposure image should be used for that region (based on the region including highlights).

In some examples, systems and techniques are described for generating a high dynamic range (HDR) image without ghosting artifacts at least in part by merging multiple images corresponding to different exposure times, with one of the images modified via exposure compensation to simulate a different exposure. An imaging system can receive a first image captured by an image sensor according to a first exposure time. The imaging system can generate a modified image based on the first image at least in part by modifying the first image using a gain setting. The gain setting is configured so that the first image is modified to simulate a second exposure time based on exposure compensation. In an illustrative example, the first exposure is a short exposure time, the second exposure time is a long exposure time, and the gain setting brightens the first image (that was captured with a short exposure time) so that the modified image appears similar to an image captured with the long exposure time. The imaging system generates a high dynamic range (HDR) image at least in part by merging multiple images. The multiple images include a second-exposure image that corresponds to the second exposure time. The second-exposure image can be the modified image. The second-exposure image can be based on the modified image, for instance being a processed variant of the modified image (e.g., with noise reduction processing based on one or more other images actually captured using the second exposure time).

Using the modified image to generate the HDR image can provide technical improvements over HDR images generated without use of the modified image. Using the modified image to generate the HDR image can eliminate or reduce the appearance of ghosting and/or other visual artifacts that might appear in HDR images generated without use of the modified image. For example, where a conflict exists between which image the HDR image should draw from based on region brightness (e.g., highlights, shadows) and which image the HDR image should draw from based on region movement and anchor selection, use of the modified image can eliminate or reduce ghosting and/or other visual artifacts that might otherwise be produced by that conflict. Furthermore, generating the second-exposure image using a noise reduction operation based on modified image and one or more images that are actually captured using the second exposure time can ensure that the HDR image retains texture details from the images that are actually captured using the second exposure.

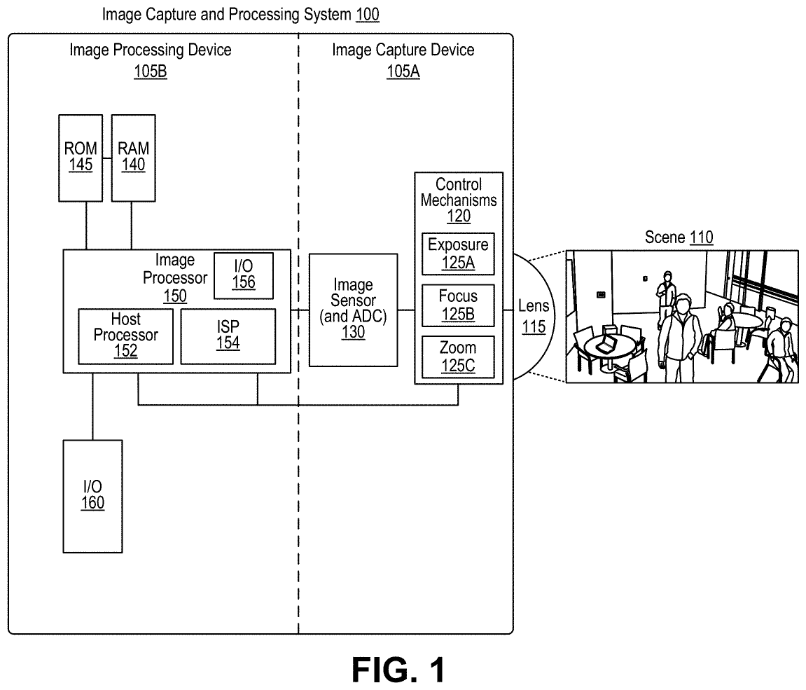

Various aspects of the application will be described with respect to the figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1110 discussed with respect to the computing system 1100. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 1120, read-only memory (ROM) 145 and/or 1125, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1135, any other input devices 1145, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral device and/or transmit data to the one or more peripheral devices. The I/O 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

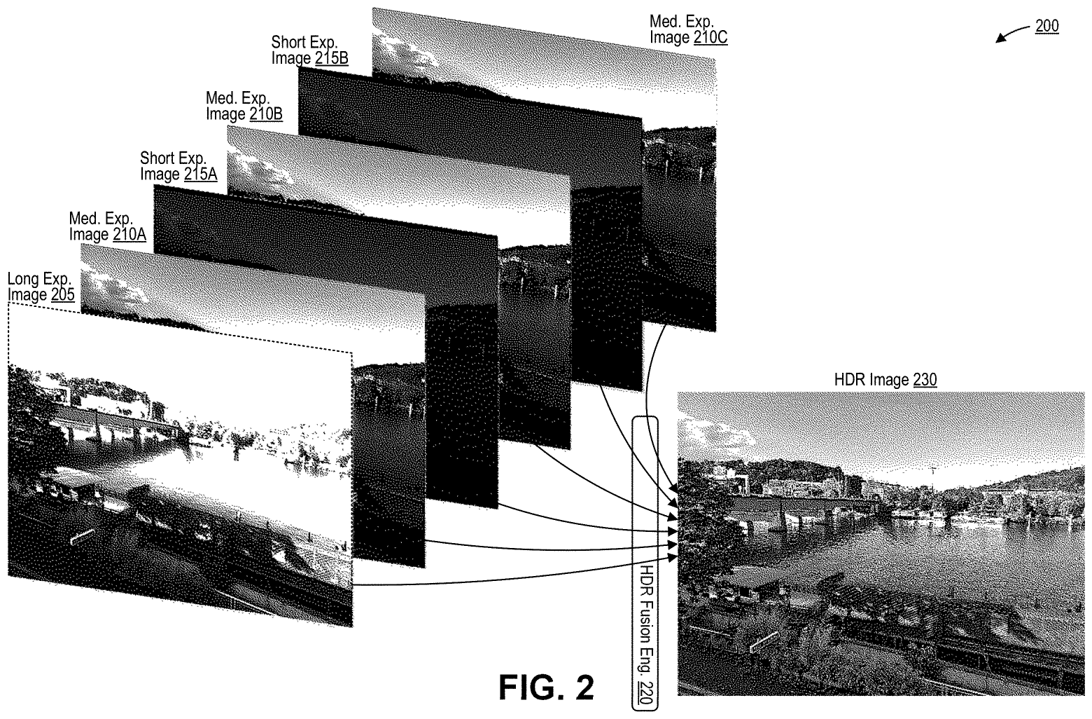

FIG. 2 is a conceptual diagram 200 illustrating multiple images of a scene having different exposures being merged into a high dynamic range (HDR) image 230 of the scene. The scene depicts a body of water between a nearby landmass and a faraway landmass. A bridge is depicted on the left side of the images, connecting the nearby landmass to the faraway landmass. Both the nearby landmass and the faraway landmass include buildings and trees.

The HDR image 230 is generated using an HDR fusion engine 220 based on a long exposure image 205 of the scene, a first medium exposure image 210A of the scene, a first short exposure image 215A of the scene, a second medium exposure image 210B of the scene, a second short exposure image 215B of the scene, and a third medium exposure image 210C of the scene. The long exposure image 205 is captured by an image sensor according to a long exposure time.

The medium exposure images 210A-210C are captured by one or more image sensors according to a medium exposure time that is shorter than the long exposure time. The short exposure images 215A-215B are captured by one or more image sensors according to a short exposure time that is shorter than the medium exposure time and the long exposure time.

In some examples, each of the images is captured by the same image sensor. For instance, the image sensor can capture some of the images one after another. In some cases, the image sensors can be configured so that different photodiodes are read out and/or reset at different times, allowing different photodiodes to capture image data for different images (e.g., according to different exposures in some instances). In some examples, some of the images are captured by different image sensors, for example by image sensors that are adjacent to one another. Examples of the image sensor(s) that capture the images of FIG. 2 can include the image sensor 130 of FIG. 1.

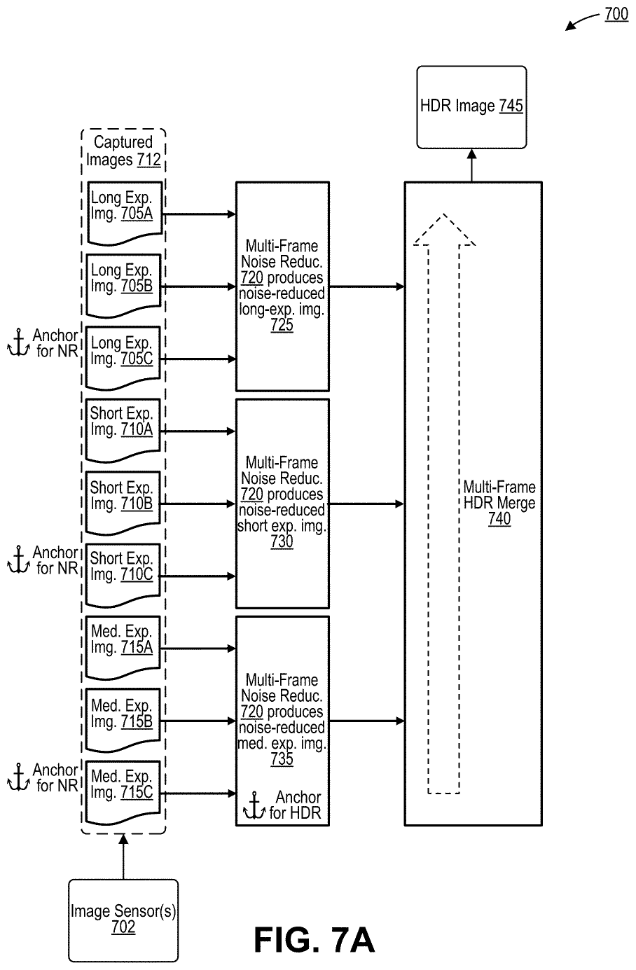

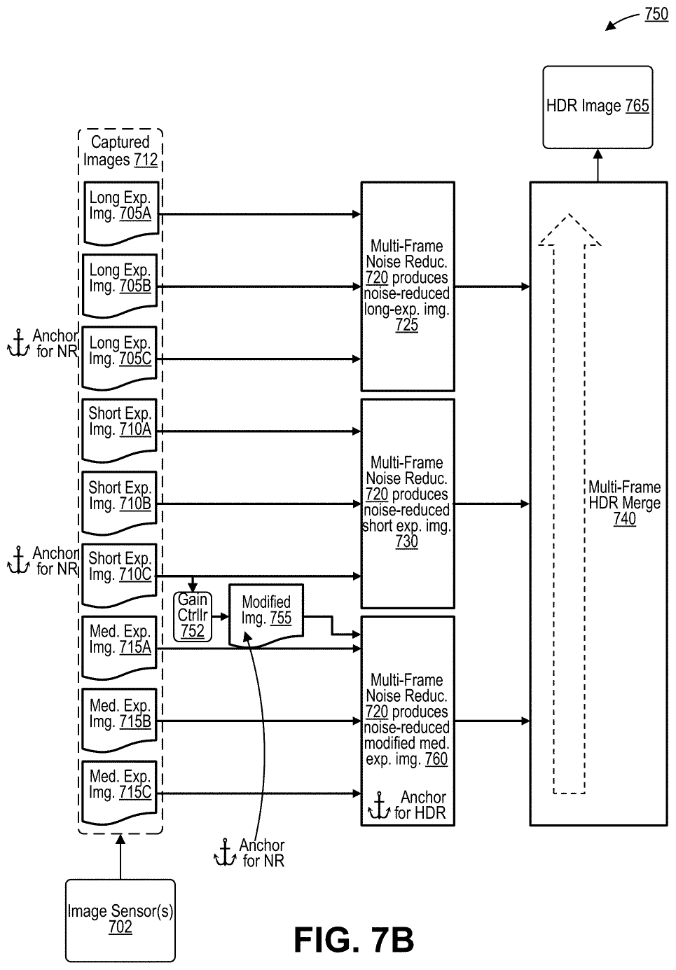

As is visible from the multiple images illustrated in FIG. 2, the multiple images can include more than one image captured according to each exposure time, as in the medium exposure images 210A-210C and the short exposure images 215A-215B. In some examples (e.g., see FIGS. 7A-7B), the multiple images can include more than one long-exposure image.

The long exposure image 205 is more exposed than the medium exposure images 210A-210C and the short exposure images 215A-215B. The long exposure image 205 is thus generally brighter than the medium exposure images 210A-210C and the short exposure images 215A-215B. Because the long exposure image 205 is generally bright, it preserves more detail in the shadows (dark areas) of the scene, such as much of the nearby landmass in the scene. The medium exposure images 210A-210B and the short exposure images 215A-215C are generally darker than long exposure image 205, and thus may be underexposed (e.g., too dark to make out details in) in the shadows (dark areas) of the scene, making their depictions of the shadows of the scene too dark to see details in. For instance, in the short exposure images 215A-215B, most of the nearby landmass appears so dark as to appear black, with little or no discernable details. The nearby landmass even appears considerably darker and less detailed in the medium exposure images 210A-210C than in the long exposure image 205.

The short exposure images 215A-215B are less exposed than the medium exposure images 210A-210C and the long exposure image 205. The short exposure images 215A-215B are thus generally darker than the medium exposure images 210A-210C and the long exposure image 205. Because the short exposure images 215A-215B are generally dark, they preserve the most detail in the highlights (bright areas) of the scene, such as parts of the sky and lights along the edge of the faraway landmass in the scene. The medium exposure images 210A-210B and the long exposure image 205 are generally brighter than short exposure images 215A-215B, and thus may be overexposed (e.g., too bright to make out details in) in the highlights (bright areas) of the scene, making their depictions of the highlights of the scene too bright to see details in. For instance, in the long exposure image 205, much of the sky and parts of the water appear to bright as to appear white, with little or no discernable details. Parts of the sky and parts of the water appear even appears considerably brighter and less detailed in the medium exposure images 210A-210C than in the short exposure images 215A-215B.

The medium exposure images 210A-210C are less exposed than the long exposure image 205 but more exposed than the short exposure images 215A-215B. Many of the parts of the scene that are neither highlights nor shadows appear detailed in the medium exposure images 210A-210C. Despite this, the medium exposure images 210A-210C suffer from both overexposure in some areas (e.g., some of the highlights of the scene) and underexposure in other areas (e.g., some of the shadows of the scene).

In some examples, shorter exposure images (such as the short exposure images 215A-215B) can provide higher dynamic range than longer exposure images (such as the long exposure image 205). In some examples, shorter exposure images (such as the short exposure images 215A-215B) can include more noise than longer exposure images (such as the long exposure image 205). In some examples, longer exposure images (such as the long exposure image 205) can provide lower dynamic range than shorter exposure images (such as the short exposure images 215A-215B). In some examples, longer exposure images (such as the long exposure image 205) can include less noise than shorter exposure images (such as the short exposure images 215A-215B). Thus, it may be useful to perform noise reduction for shorter exposure images, for example by capturing multiple shorter exposure images and averaging pixel values between the shorter exposure images.

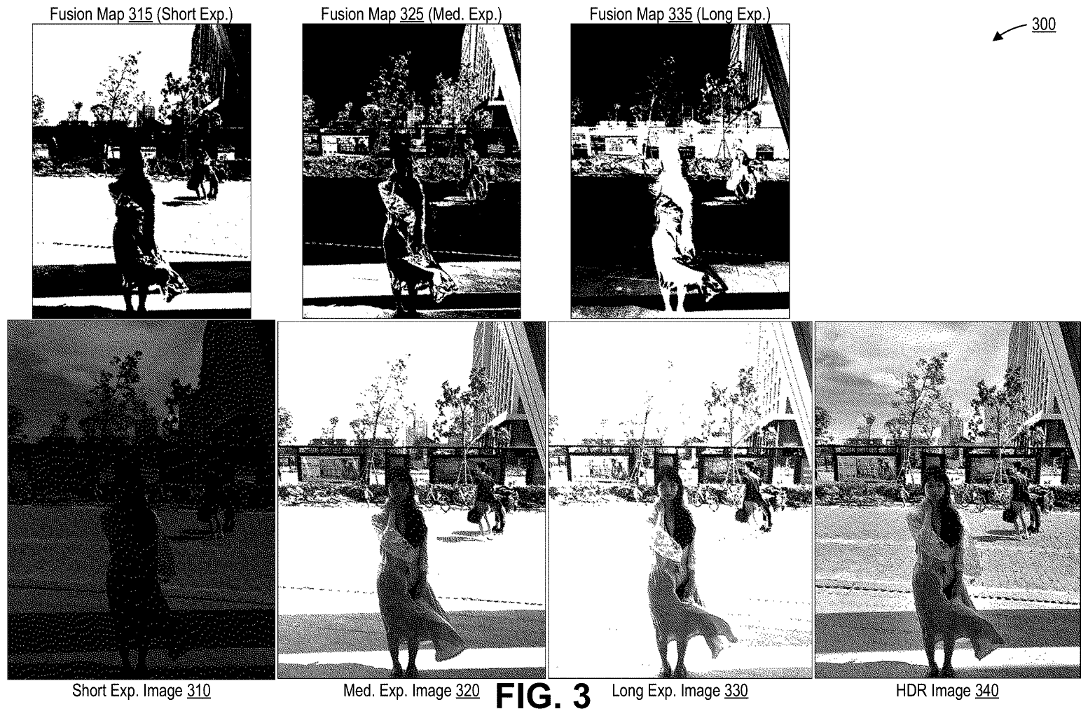

The HDR image 230 is generated by the HDR fusion engine 220 by merging at least a subset of the long exposure image 205 of the scene, the first medium exposure image 210A of the scene, the first short exposure image 215A of the scene, the second medium exposure image 210B of the scene, the second short exposure image 215B of the scene, and the third medium exposure image 210C of the scene. The HDR fusion engine 220 can preserve details in the HDR image 230's depiction of the highlights of the scene by drawing primarily from the short exposure images 215A-215B and/or the medium exposure images 210A-210C to generate the HDR image 230's depiction of the highlights of the scene. The HDR fusion engine 220 can preserve details in the HDR image 230's depiction of the shadows of the scene by drawing primarily from the long exposure image 205 and/or the medium exposure images 210A-210C to generate the HDR image 230's depiction of the shadows of the scene. The HDR fusion engine 220 can preserve details in the HDR image 230's depiction of the regions of the scene that are neither highlights nor shadows by drawing primarily from the medium exposure images 210A-210C to generate the HDR image 230's depiction of the regions of the scene that are neither highlights nor shadows. The HDR fusion engine 220 can select which of the images it draws from using HDR fusion maps, such as the HDR fusion maps 315, 325, and 335 of FIG. 3.

FIG. 3 is a conceptual diagram 300 illustrating multiple images (310, 320, 330) of a scene having different exposures being merged into a high dynamic range (HDR) image 340 of the scene according to one or more fusion maps (315, 325, 335). The scene depicts a woman standing on a street in front of a sidewalk, garden that is on the sidewalk, a person exercising on the sidewalk, a building, and the sky. The building is off to the right in the scene and casts a shadow onto the street.

The HDR image 340 is generated using an HDR fusion engine 220 based on a short exposure image 310 of the scene, a medium exposure image 320 of the scene, and a long exposure image 330 of the scene. The long exposure image 330 is captured by an image sensor according to a long exposure time. The medium exposure image 320 are captured by either the same image sensor or a different image sensor according to a medium exposure time that is shorter than the long exposure time. The short exposure image 310 are captured by either the same image sensor or a different image sensor according to a short exposure time that is shorter than the medium exposure time and the long exposure time.

The HDR fusion engine 220 generates the HDR image 340 according to one or more fusion maps 315, 325, and 335. In particular, a short exposure fusion map 315 identifies areas of the scene (e.g., highlights) in white or light grey where the HDR fusion engine 220 primarily draws from the short exposure image 310 to generate the HDR image 340, and identifies other areas of the scene (e.g., not highlights) in black or dark grey where the HDR fusion engine 220 primarily draws from other images besides the short exposure image 310 (e.g., the medium exposure image 320 and/or the long exposure image 330) to generate the HDR image 340. A long exposure fusion map 335 identifies areas of the scene (e.g., shadows) in white or light grey where the HDR fusion engine 220 primarily draws from the long exposure image 330 to generate the HDR image 340, and identifies other areas of the scene (e.g., not shadows) in black or dark grey where the HDR fusion engine 220 primarily draws from other images besides the long exposure image 330 (e.g., the medium exposure image 320 and/or the short exposure image 310) to generate the HDR image 340. A medium exposure fusion map 325 identifies areas of the scene (e.g., not highlights and not shadows) in white or light grey where the HDR fusion engine 220 primarily draws from the medium exposure image 320 to generate the HDR image 340, and identifies other areas of the scene (e.g., highlights or shadows) in black or dark grey where the HDR fusion engine 220 primarily draws from other images besides the long exposure image 330 (e.g., the long exposure image 330 and/or the short exposure image 310) to generate the HDR image 340.

In some examples, the fusion maps 315, 325, and 335 may be separate maps as illustrated in FIG. 3. In some examples, the fusion maps 315, 325, and 335 may be merged into a single map, for instance with different colors or values representing the different areas of the fusion map. For example, areas where the HDR fusion engine 220 primarily draws from the short exposure image 310 can be identified as a first color, areas where the HDR fusion engine 220 primarily draws from the medium exposure image 320 can be identified as a second color, and areas where the HDR fusion engine 220 primarily draws from the long exposure image 330 can be identified a third color. In some examples, the first, second, and third colors, may be red, green, and blue respectively.

The short exposure image 310 is less exposed and thus darker than the medium exposure image 320 and the long exposure image 330. The short exposure image 310 thus preserves more detail in the highlights (bright areas) of the scene, such as the sky, bright parts of the street, much of the sidewalk, bright areas of the woman's dress, and bright areas of the garden and building. These areas of the scene are identified in white or light grey in the short exposure fusion map 315, and thus the HDR fusion engine 220 primarily draws from the short exposure image 310 to generate the HDR image 340's depictions of these areas of the scene. These areas of the scene generally appear too bright in the long exposure image 330 and/or in the medium exposure image 320, with details of these areas of the scene lost in those images.

The long exposure image 330 is more exposed and thus brighter than the medium exposure image 320 and the short exposure image 310. The long exposure image 330 thus preserves more detail in the shadows (dark areas) of the scene, such as the woman's face, hair, legs, some of the shadows in the street, much of the person exercising on the sidewalk, and dark areas of the garden and building. These areas of the scene are identified in white or light grey in the long exposure fusion map 335, and thus the HDR fusion engine 220 primarily draws from the long exposure image 330 to generate the HDR image 340's depictions of these areas of the scene. These areas of the scene generally appear too dark in the short exposure image 310 and/or in the medium exposure image 320, with details of these areas of the scene lost in those images.

The medium exposure image 320 are less exposed than the long exposure image 330 but more exposed than the short exposure image 310. The medium exposure image 320 thus preserves more detail in areas of the scene that are neither highlights nor shadows, such as much of the woman's clothing, some parts of the street, some of the person exercising on the sidewalk, some parts of the garden, and some parts of the building. These areas of the scene are identified in white or light grey in the medium exposure fusion map 325, and thus the HDR fusion engine 220 primarily draws from the medium exposure image 320 to generate the HDR image 340's depictions of these areas of the scene. These areas of the scene generally appear too dark in the short exposure image 310 and/or too bright in the long exposure image 330, with details of these areas of the scene lost in those images.

In some examples, the fusion maps 315, 325, and 335 may map certain areas of the scene based on whether the areas are static or in motion. For instance, part of the woman's dress is blowing in the wind and thus appears to be in motion, while much of the rest of the scene appears to be static. An anchor image may be selected, for instance based on a user input and/or automatically by an imaging device. The fusion maps 315, 325, and 335 may map areas of the scene that are in motion based on which of the images are selected to the anchor image. If the short exposure image 310 is selected to be the anchor for the HDR image 340, the moving area (the part of the woman's dress that is blowing in the wind) may appear sharp in the HDR image 340 because the depiction of the moving area in HDR image 340 is most dominantly based on the depiction of the moving area in the short exposure image 310, which is sharp. If the long exposure image 330 is selected to be the anchor for the HDR image 340, the moving area (the part of the woman's dress that is blowing in the wind) may appear blurry (e.g., due to motion blur) in the HDR image 340 because the depiction of the moving area in HDR image 340 is most dominantly based on the depiction of the moving area in the long exposure image 330, which is blurry (e.g., due to motion blur).

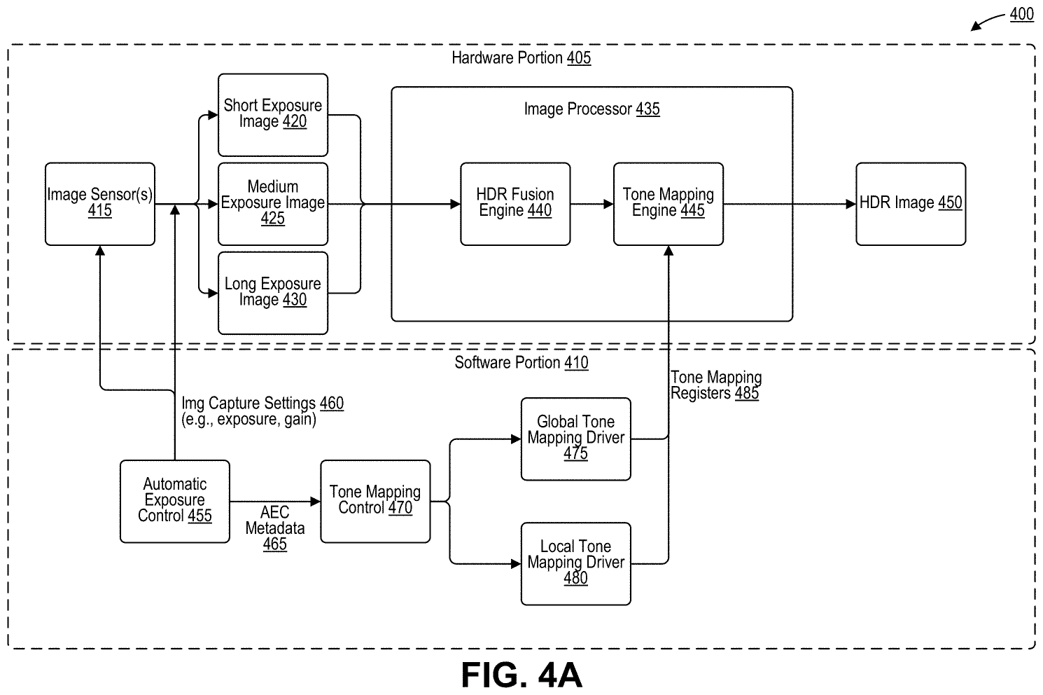

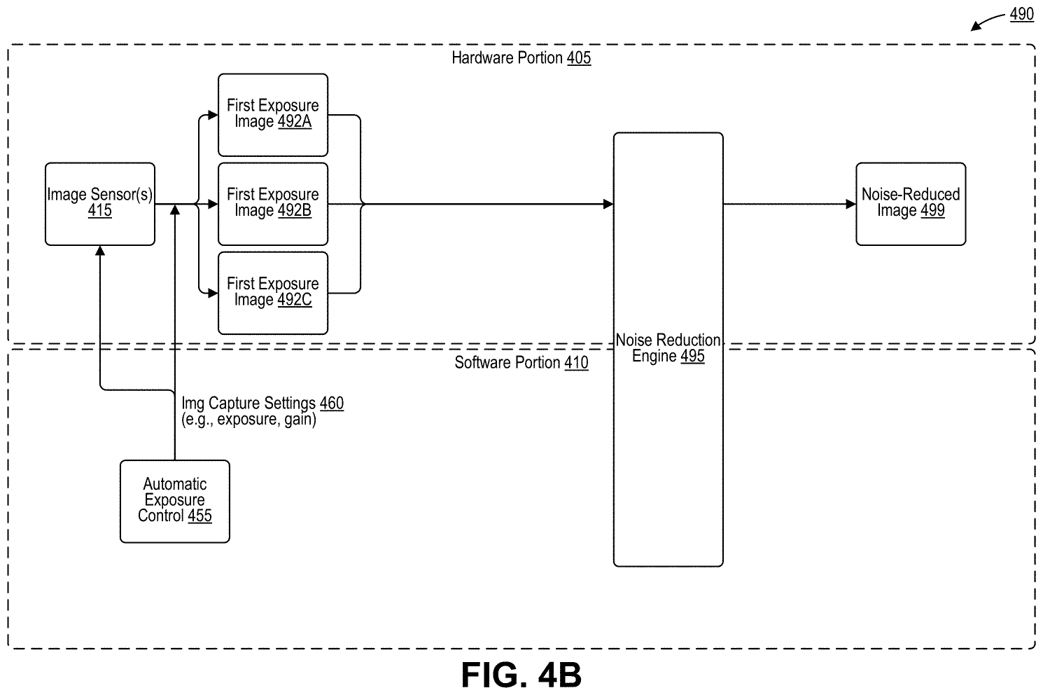

FIG. 4A is a block diagram illustrating an example architecture of an imaging system 400 that merges multiple images 420-430 of a scene to generate a high dynamic range (HDR) image 450 of a scene. The imaging system includes a hardware portion 405 and a software portion 410. The hardware portion 405 includes an image sensor 415 that captures a short exposure image 420 according to a short exposure time, a medium exposure image 425 according to a medium exposure time, and a long exposure image 430 according to a long exposure time. The image sensor(s) 415 can be an example of the image sensor 130. The software portion 410 includes an automatic exposure control (AEC) 455, which can generate image capture settings 460 such as exposure time, analog gain, digital gain, aperture size, ISO, and/or other image capture settings associated with exposure 125A and/or other control mechanisms 120. The AEC 455 can send the image capture settings 460 to the image sensor 415 and/or to associated control mechanisms (e.g., as in control mechanisms 120). The image capture settings 460 can include, for example, the short exposure time according to which the image sensor(s) 415 capture the short exposure time 420, the medium exposure time according to which the image sensor(s) 415 capture the medium exposure time 425, and/or the long exposure time according to which the image sensor(s) 415 capture the long exposure time 430.

The hardware portion 405 may also include an image processor 435, which may include an HDR fusion engine 440 and a tone mapping engine 445. The image processor 435 may be an example of the image processing device 105B, the image processor 150, the ISP 154, the host processor 152, or a combination thereof. The HDR fusion engine 220 may be an example of the HDR fusion engine 440. The HDR fusion engine 440 may fuse the short exposure image 420, the medium exposure image 425, and/or the long exposure image 430. In some examples, the HDR fusion engine 440 may generate one or more fusion maps, such as the fusion maps 315, 325, and 335 of FIG. 3. In some examples, the HDR fusion engine 440 may fuse the short exposure image 420, the medium exposure image 425, and/or the long exposure image 430 according to the one or more fusion maps. In some examples, the HDR fusion engine 440 may generate the fusion maps and/or fuse the images based on scene brightness (e.g., highlights, shadows, or neither) and/or motion (e.g., static regions, moving regions).

The AEC 455 may also generate AEC metadata 465, which can include for example dynamic range compression (DRC) gain, DRC gain dark (e.g., for shadows), and/or histogram statistics. The AEC 455 may transfer the AEC metadata 465 to a tone mapping control (TMC) 470 of the software portion 410. The tone mapping control (TMC) 470 can generate a target tone curve and/or a contrast enhancement curve based on the AEC metadata 465. The TMC 470 can send the target tone curve and/or a contrast enhancement curve and/or AEC metadata 465 to a global tone mapping driver 475, which can generate global tone mapping settings based on the target tone curve and/or contrast enhancement curve and/or AEC metadata 465. The global tone mapping driver 475 can provide the global tone mapping settings to the tone mapping engine 445 (e.g., in the form of values in tone mapping registers 485). The TMC 470 can send the target tone curve and/or a contrast enhancement curve and/or AEC metadata 465 to a local tone mapping driver 480, which can generate local tone mapping settings based on the target tone curve and/or contrast enhancement curve and/or AEC metadata 465. The local tone mapping driver 480 can provide the local tone mapping settings to the tone mapping engine 445 (e.g., in the form of values in tone mapping registers 485). The tone mapping engine 445 can perform tone mapping on the HDR image generated by the HDR fusion engine 440 to adjust global and local gain across the HDR image generated by the HDR fusion engine 440 based on the tone mapping registers 485, the global tone mapping settings, the local tone mapping settings, or a combination thereof. Tone mapping can be used to better align brightness ranges between, and/or provide a smoother blending transition between, different regions of the image that are taken from different input images (e.g., the short exposure image 420, the medium exposure image 425, and/or the long exposure image 430).

FIG. 4B is a block diagram illustrating an example architecture of an imaging system 490 that merges multiple images of a scene to generate a noise-reduced image of the scene. The imaging system 490 retains the hardware portion 405, the software portion 410, the image sensor(s) 415, and the AEC 455 of the imaging system 400. The image sensor(s) 415, in the imaging system 490, capture multiple images according to the same exposure, referred to as a first exposure time. The images are thus referred to as the first exposure images 492A-492C. The imaging system 490 includes a noise reduction (NR) engine 495, which merges the first exposure images 492A-492C into a single noise-reduced image 499 using a noise reduction algorithm. The noise reduction engine 495 may be part of the hardware portion 405, part of the software portion 410, or a combination thereof. In some examples, the noise reduction engine 495 may be part of the image processor 435. The NR engine 495 may reduce noise, for example, by averaging corresponding pixel values (e.g., mean, median, and/or mode) between the first exposure images 492A-492C.

In some examples, the first exposure images 492A-492C may be slightly different, for example because they may be captured one after another and thus may depict the scene at slightly different points in time. One or more moving objects or areas may be at slightly different positions, orientations, and/or poses at the slightly different times, which may be reflected in the depictions of those objects or areas in the different first exposure images 492A-492C. In some examples, one of the first exposure images 492A-492C may be selected to be an anchor image for the noise reduction process performed by the noise reduction engine 495. Selection of the NR anchor can be performed manually via a user interface selection, automatically by the imaging device (e.g., by the NR engine 495), or a combination thereof. For noise reduction, the anchor image can control for pixels and/or regions where the first exposure images 492A-492C are significantly different (e.g., by more than a threshold amount). For instance, if the first exposure images 492A-492C depict a moving vehicle that is in a slightly different position in each of the first exposure images 492A-492C, and the first exposure images 492A is selected to be the anchor image for NR, then the edges of the vehicle (and thus the vehicle's position in the scene) in the anchor image (the first exposure images 492A) can control and become the edges of the vehicle (and thus the vehicle's position in the scene) in the noise-reduced image 499.

In some examples, the imaging system 490 may be part of the imaging system 400, or vice versa. For example, the short exposure image 420 may be a noise-reduced image 499 generated based on several short exposure images (e.g., short exposure images 215A-215B, short exposure images 710A-710C). Similarly, the medium exposure image 425 may be a noise-reduced image 499 generated based on several medium exposure images (e.g., medium exposure images 210A-210C, medium exposure images 715A-715C). The long exposure image 430 may be a noise-reduced image 499 generated based on several long exposure images (e.g., long exposure images 705A-705C).

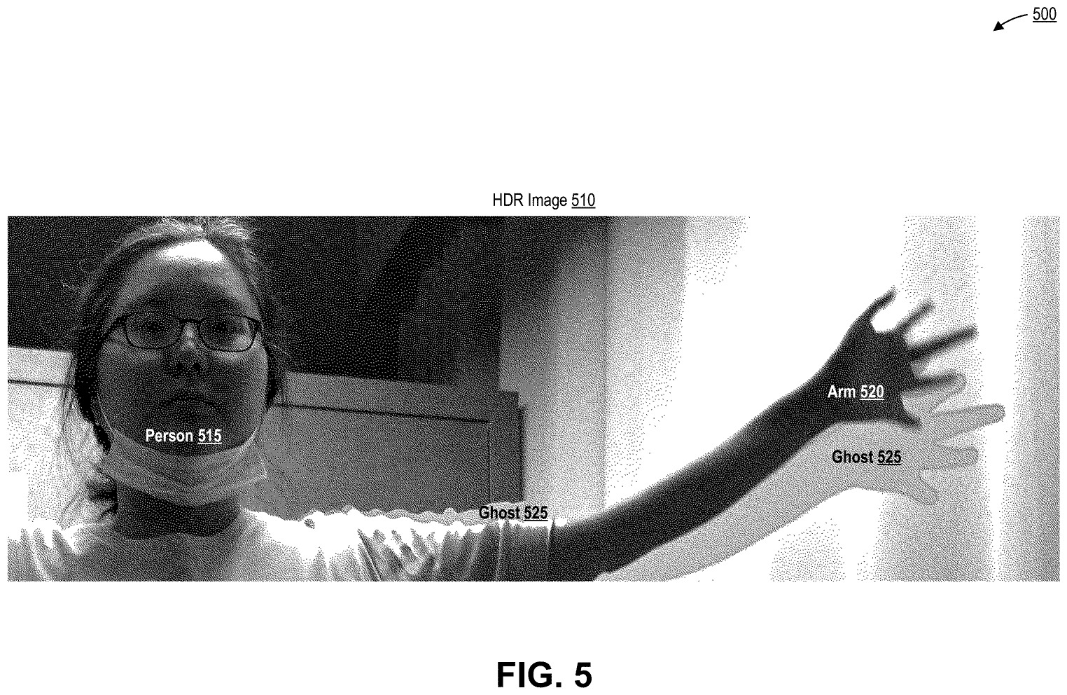

FIG. 5 is a conceptual diagram 500 illustrating a high dynamic range (HDR) image 510 depicting a person 515 and including a ghost 525 of an arm 520 of the person 515. While HDR generally works well for static objects, such as the person 515's face, sometimes HDR can produce visual artifacts, such as ghosts 525, in images depicting moving objects, such as the arm 520. For example, visual artifacts such as ghosts 525 can occur as a result of a conflicts between which image the HDR image draws from based on region brightness (e.g., highlights, shadows) and which image the HDR image draws from based on movement and HDR anchor selection. Examples of such conflicts include the conflict 680 and the conflict 685.

HDR anchor selection refers to selection of one of the multiple images that are merged to form an HDR image 450 to be an anchor image for the HDR image 450. The anchor image can be dominant in terms of determining how certain elements depicted in the HDR image appear, such as moving objects. For instance, an object that is moving in a photographed scene, such as a moving vehicle driving along a road, may appear sharp in a short-exposure image captured with a short exposure time, but may appear blurry (e.g., due to motion blur) in a long-exposure captured with a long exposure time. If the short-exposure image is selected to be the anchor for the HDR image, the moving vehicle may appear sharp in the HDR image because the depiction of the moving vehicle in HDR image is most dominantly based on the depiction of the moving vehicle in the short-exposure image, rather than the depiction of the moving vehicle in the long-exposure image. If the long-exposure image is selected to be the anchor for the HDR image, the moving vehicle may appear blurry (e.g., due to motion blur) in the HDR image because the depiction of the moving vehicle in HDR image is most dominantly based on the depiction of the moving vehicle in the long-exposure image, rather than the depiction of the moving vehicle in the short-exposure image. Selection of the HDR anchor can be performed manually via a user interface selection, automatically by the imaging device (e.g., by the HDR fusion engine 440), or a combination thereof.

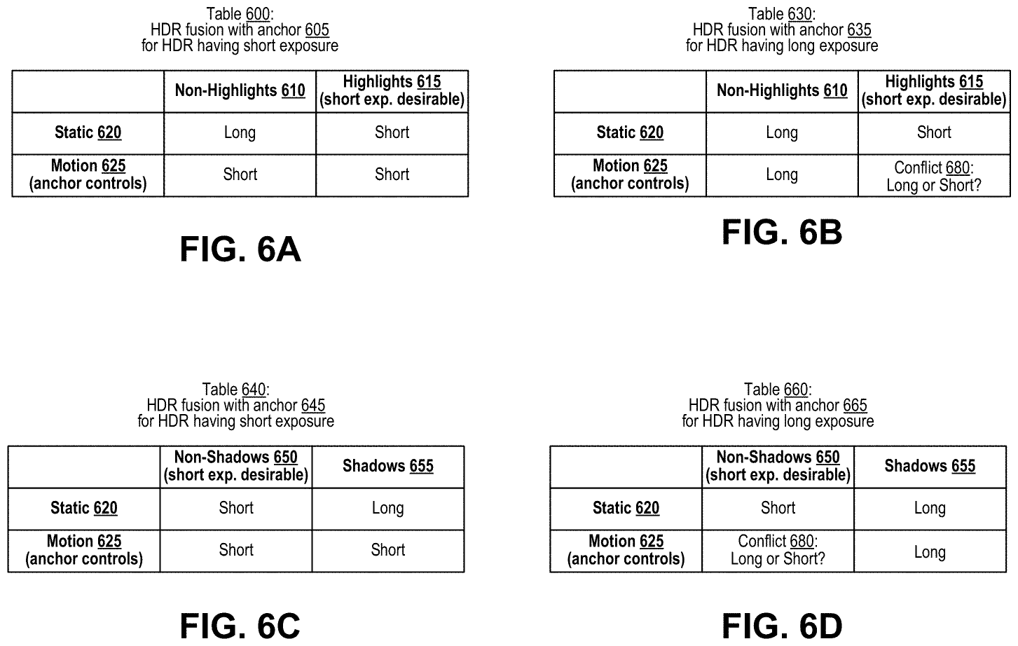

FIG. 6A is a table 600 illustrating high dynamic range (HDR) fusion for different regions of a scene, with a HDR anchor 605 having a short exposure and with highlights 615 corresponding to short exposure. Because short exposure images are generally darker and include more detail in highlights 615 of a scene, the an imaging system (indicated by the table 600) directs the HDR fusion engine 440 to rely on the short exposure image for the highlights 615 of the scene in generating the HDR image 450, including both areas that are static 620 and areas that are in motion 625. Because the HDR anchor 605 is the short exposure image, the imaging system (indicated by the table 600) directs the HDR fusion engine 440 to rely on the short exposure image for the areas in motion 625 in the scene in generating the HDR image 450, including both highlights 615 and non-highlights 610. Only non-highlights 610 that are static 620 remain, and the imaging system (indicated by the table 600) directs the HDR fusion engine 440 to rely on the long exposure image for non-highlights 610 that are static 620 in the scene in generating the HDR image 450.

FIG. 6B is a table 630 illustrating high dynamic range (HDR) fusion for different regions of a scene, with a HDR anchor 635 having a long exposure and with highlights 615 corresponding to short exposure, resulting in a conflict 680. Because short exposure images are generally darker and include more detail in highlights 615 of a scene, the imaging system (indicated by the table 630) directs the HDR fusion engine 440 to rely on the short exposure image for the highlights 615 of the scene in generating the HDR image 450, including both areas that are static 620 and areas that are in motion 625. Because the HDR anchor 635 is the long exposure image, the imaging system (indicated by the table 630) directs the HDR fusion engine 440 to rely on the long exposure image for the areas in motion 625 in the scene in generating the HDR image 450, including both highlights 615 and non-highlights 610. This produces a conflict 680 for areas that are highlights 615 and in motion 625, because the areas being highlights 615 suggests reliance on the short exposure image in generating the HDR image 450, while the areas being in motion 625 (and the HDR anchor 635 being the long exposure image) suggests reliance on the long exposure image in generating the HDR image 450. The conflict 680 can result in the HDR fusion engine 440 producing an HDR image 450 with visual artifacts, such as the ghost 525 in the HDR image 510. For instance, the HDR fusion engine 440 can end up treating part of an area in motion 625 (e.g., a highlight 615) differently than another part of the area in motion 625 (e.g., a non-highlight 610). In some cases, parts of backgrounds behind a moving object can be considered an area in motion 625, such as parts of the background behind the arm 520. As in the table 600, the imaging system (indicated by the table 630) directs the HDR fusion engine 440 to rely on the long exposure image for non-highlights 610 that are static 620 in the scene in generating the HDR image 450.

FIG. 6C is a table 640 illustrating high dynamic range (HDR) fusion for different regions of a scene, with a HDR anchor 645 having a short exposure and with non-shadows 650 corresponding to short exposure. The HDR anchor 645 can be the same as the HDR anchor 605. Because short exposure images are generally darker and include more detail in non-shadows 650 of a scene, the imaging system (indicated by the table 640) directs the HDR fusion engine 440 to rely on the short exposure image for the non-shadows 650 of the scene in generating the HDR image 450, including both areas that are static 620 and areas that are in motion 625. Because the HDR anchor 645 is the short exposure image, the imaging system (indicated by the table 640) directs the HDR fusion engine 440 to rely on the short exposure image for the areas in motion 625 in the scene in generating the HDR image 450, including both shadows 655 and non-shadows 650. The imaging system (indicated by the table 640) directs the HDR fusion engine 440 to rely on the short exposure image for non-shadows 650 that are static 620 in the scene in generating the HDR image 450.

FIG. 6D is a table 660 illustrating high dynamic range (HDR) fusion for different regions of a scene, with a HDR anchor 665 having a long exposure and with non-shadows 650 corresponding to short exposure, resulting in a conflict 685. The HDR anchor 665 can be the same as the HDR anchor 635. Because short exposure images are generally darker and include more detail in non-shadows 650 of a scene, the imaging system (indicated by the table 660) directs the HDR fusion engine 440 to rely on the short exposure image for the non-shadows 650 of the scene in generating the HDR image 450, including both areas that are static 620 and areas that are in motion 625. Because the HDR anchor 665 is the long exposure image, the imaging system (indicated by the table 660) directs the HDR fusion engine 440 to rely on the long exposure image for the areas in motion 625 in the scene in generating the HDR image 450, including both shadows 655 and non-shadows 650. This produces a conflict 685 for areas that are non-shadows 650 and in motion 625, because the areas being non-shadows 650 suggests reliance on the short exposure image in generating the HDR image 450, while the areas being in motion 625 (and the HDR anchor 665 being the long exposure image) suggests reliance on the long exposure image in generating the HDR image 450. The conflict 685 can result in the HDR fusion engine 440 producing an HDR image 450 with visual artifacts, such as the ghost 525 in the HDR image 510. For instance, the HDR fusion engine 440 can end up treating part of an area in motion 625 (e.g., a shadow 655) differently than another part of the area in motion 625 (e.g., a non-shadow 650). The imaging system (indicated by the table 660) directs the HDR fusion engine 440 to rely on the short exposure image for non-shadows 650 that are static 620 in the scene in generating the HDR image 450.

In some examples, shadows 655 can correspond to long exposure, which can result in a conflict. Because long exposure images are generally brighter and include more detail in shadows 655 of a scene, the imaging system can directs the HDR fusion engine 440 to rely on the long exposure image for the shadows 655 of the scene in generating the HDR image 450, including both areas that are static 620 and areas that are in motion 625. If the HDR anchor is a long exposure image (as in table 630 and table 660), the imaging system can direct the HDR fusion engine 440 to rely on the long exposure image for the areas in motion 625 in the scene in generating the HDR image 450, including both shadows 655 and non-shadows 650, which would not conflict with the imaging system's instruction to use long exposure images for shadows 655. However, if the HDR anchor is a short exposure image (as in table 600 and table 640) the imaging system can direct the HDR fusion engine 440 to rely on the short exposure image for the areas in motion 625 in the scene in generating the HDR image 450, including both shadows 655 and non-shadows 650. This can produces a conflict for areas that are shadows 655 and in motion 625, because the areas being shadows 655 can suggest reliance on the long exposure image in generating the HDR image 450, while the areas being in motion 625 (and the HDR anchor being the short exposure image) can suggest reliance on the short exposure image in generating the HDR image 450. The conflict can result in the HDR fusion engine 440 producing an HDR image 450 with visual artifacts, such as the ghost 525 in the HDR image 510. For instance, the HDR fusion engine 440 can end up treating part of an area in motion 625 (e.g., a shadow 655) differently than another part of the area in motion 625 (e.g., a non-shadow 650).

With respect to FIGS. 6A-6D, the terms “short” and “long” are relative to one another. For example, if the short exposure image of FIGS. 6A-6D is a short exposure image (e.g., 215A-215B, 310, 420, 710A-710C), then the long exposure image of FIGS. 6A-6D can be a medium exposure image (e.g., 210A-210C, 320, 425, 715A-715C) or a long exposure image (e.g., 205, 330, 430, 705A-705C). If the long exposure image of FIGS. 6A-6D is a long exposure image (e.g., 205, 330, 430, 705A-705C), then the short exposure image of FIGS. 6A-6D can be a short exposure image (e.g., 215A-215B, 310, 420, 710A-710C) or a medium exposure image (e.g., 210A-210C, 320, 425, 715A-715C).

FIG. 7A is a block diagram 700 illustrating example operations of an imaging system that merges multiple noise-reduced images 725-735 of a scene to generate a high dynamic range (HDR) image 745 of the scene. An image sensor 702 captures a set of captured images 712, which include three long exposure images 705A-705C, three short exposure image 710A-710C, and three medium exposure images 715A-715C.

The imaging system (e.g., a NR engine 495) performs multi-frame noise reduction 720 on the long exposure images 705A-705C to produce a noise-reduced long exposure image 725, with the third long exposure image 705C selected as the NR anchor for the multi-frame NR 720 of the long exposure images 705A-705C. The imaging system (e.g., a NR engine 495) performs multi-frame noise reduction 720 on the short exposure images 710A-710C to produce a noise-reduced short exposure image 730, with the third short exposure image 710C selected as the NR anchor for the multi-frame NR 720 of the short exposure images 710A-710C. The imaging system (e.g., a NR engine 495) performs multi-frame noise reduction 720 on the medium exposure images 715A-715C to produce a noise-reduced medium exposure image 730, with the third medium exposure image 715C selected as the NR anchor for the multi-frame NR 720 of the medium exposure images 715A-715C.

The imaging system (e.g., a HDR fusion engine 440 and/or tone mapping engine 445) produces the HDR image 745 by performing multi-frame HDR merging 740 on the noise-reduced long exposure image 725, the noise-reduced short exposure image 730, and the noise-reduced medium exposure image 735. The noise-reduced medium exposure image 735 is selected as the HDR anchor for the multi-frame HDR merging 740 of the noise-reduced long exposure image 725, the noise-reduced short exposure image 730, and the noise-reduced medium exposure image 735. The dashed upward arrow indicates that the imaging system starts from the anchor image to produce the HDR image 745.

FIG. 7B is a block diagram 750 illustrating example operations of an imaging system that merges multiple noise-reduced images (725, 730, and 760) of a scene to generate a high dynamic range (HDR) image 765 of the scene, with one of the noise-reduced images (760) being based on a modified image 755 that simulates a different exposure via exposure compensation. As in FIG. 7A, the image sensor 702 captures the set of captured images 712.

The imaging system (e.g., a NR engine 495) performs multi-frame noise reduction 720 on the long exposure images 705A-705C to produce a noise-reduced long exposure image 725 as in FIG. 7A. The imaging system (e.g., a NR engine 495) performs multi-frame noise reduction 720 on the short exposure images 710A-710C to produce a noise-reduced medium exposure image 730 as in FIG. 7A.

The imaging system uses at least a gain controller 752 to generate a modified image 755 based on the short exposure image 710C. In some examples, the gain controller 752 can be part of the tone mapping engine 445 and/or another portion of the image processor 435. In some examples, the gain controller 752 can be part of the ISP 154, the host processor 152, and/or the image processor 150. The gain controller 752 of the imaging system increases the gain of the short exposure image 710C using analog gain, digital gain, or a combination thereof, to simulate the medium exposure images 715A-715C to generate the modified image 755. The gain controller 752 can adjust the gain according to exposure compensation, for instance to bring the luminosity and/or dynamic range of the short exposure image 710C closer to the luminosity and/or dynamic range of at least a subset of the medium exposure images 715A-715C.

The imaging system (e.g., a NR engine 495) performs multi-frame noise reduction 720 on the medium exposure images 715A-715C and the modified image 755 to produce a noise-reduced modified medium exposure image 760, with the modified image 755 selected as the NR anchor for the multi-frame NR 720 of the medium exposure images 715A-715C and the modified image 755. Because the modified image 755 is the NR anchor for the NR 720 of the medium exposure images 715A-715C and the modified image 755, the resulting noise-reduced modified medium exposure image 760 illustrates moving objects positioned as in the short exposure images 710A-710C, but includes the benefits of reduced noise based on the NR 720 using the medium exposure images 715A-715C.

The imaging system (e.g., a HDR fusion engine 440 and/or tone mapping engine 445) produces the HDR image 745 by performing multi-frame HDR merging 740 on the noise-reduced long exposure image 725, the noise-reduced short exposure image 730, and the noise-reduced modified medium exposure image 760. The noise-reduced modified medium exposure image 760 is selected as the HDR anchor for the multi-frame HDR merging 740 of the noise-reduced long exposure image 725, the noise-reduced short exposure image 730, and the noise-reduced modified medium exposure image 760. The dashed upward arrow indicates that the imaging system starts from the anchor image to produce the HDR image 745. Use of the noise-reduced modified medium exposure image 760 as the anchor can reduce or eliminate ghosts 525 or other visual artifacts, for instance that might be caused by a conflict 680 and/or a conflict 685.

In some examples, the modified image 755 can be referred to as I_{P}. The short exposure anchor (short exposure image 710C) upon which the modified image 755 is based can be referred to as I_{S}. A tone ratio between at least a subset of the short exposure images 710A-710C and at least a subset of the medium exposure images 715A-715C can be referred to as γ, which can represent a gain value. Using these notations, the modified image 755 can be generated by the image processor 435 using the equation I_{P}=I_{S}×γ.

In some examples, C_{M}={I_{M}_{¹}, I_{M}_{²}, . . . , I_{M}_{^{k}}} can refer to the collection of medium exposure images 715A-715C (also including the modified image 755 in FIG. 7B). Φ_{σ}_{₁} can refer to a function of multi-frame noise reduction (MFNR) under noise profile (e.g., noise threshold) σ₁. MFNR for the medium exposure images (and the modified image 755) can be guided by the NR engine 495 according to the equation I_{MFNR<P>}=Φ_{σ}_{₁}(C_{M}|I_{P}), using I_{P} as the anchor and performing NR blending over C_{M}.

In some examples, C_{S}={I_{S}_{¹}, I_{S}_{²}, I_{S}_{^{j}}} can refer to the collection of short exposure images 710A-710C. Φ_{σ}_{₂} can refer to a function of multi-frame noise reduction (MFNR) under noise profile (e.g., noise threshold) σ₂. MFNR for the short exposure images can be guided by the NR engine 495 according to the equation I_{MFNR<S>}=Φ_{σ}_{₂}(C_{S}|I_{S}), using I_{S} as the anchor and performing NR blending over C_{S}.

In some examples, C_{L}={I_{L}_{¹}, I_{L}_{²}, . . . , I_{L}_{ⁱ}} can refer to the collection of long exposure images 705A-705C. Φ_{σ}_{₃} can refer to a function of multi-frame noise reduction (MFNR) under noise profile (e.g., noise threshold) σ₃. MFNR for the long exposure images can be guided by the NR engine 495 according to the equation I_{MFNR<L>}=Φ_{σ}_{₃}(C_{L}|I_{L}), using I_{L} as the anchor and performing NR blending over C_{L}.

In some examples, C_{HDR}={I_{MFNR<S>}, I_{MFNR<P>}, I_{MFNR<L>}} can refer to the collection of noise-reduced frames input into the multi-frame HDR merge 740, including the noise-reduced long-exposure image 725, the noise-reduced short-exposure image 730, and the noise-reduced modified medium-exposure image 760. Ψ_{σ}_{₄} can refer to the function of multi-frame high dynamic range fusion (MFHDR) under noise profile (e.g., noise threshold) σ₄. The multi frame HDR (MFHDR) merge 740 can be guided by the HDR merge engine 440 according to the equation I_{HDR}=ψ_{σ}_{₄}(C_{HDR}|I_{MFNR<P>}), using I_{MFNR<P>} as the anchor and performing HDR blending over C_{HDR}.

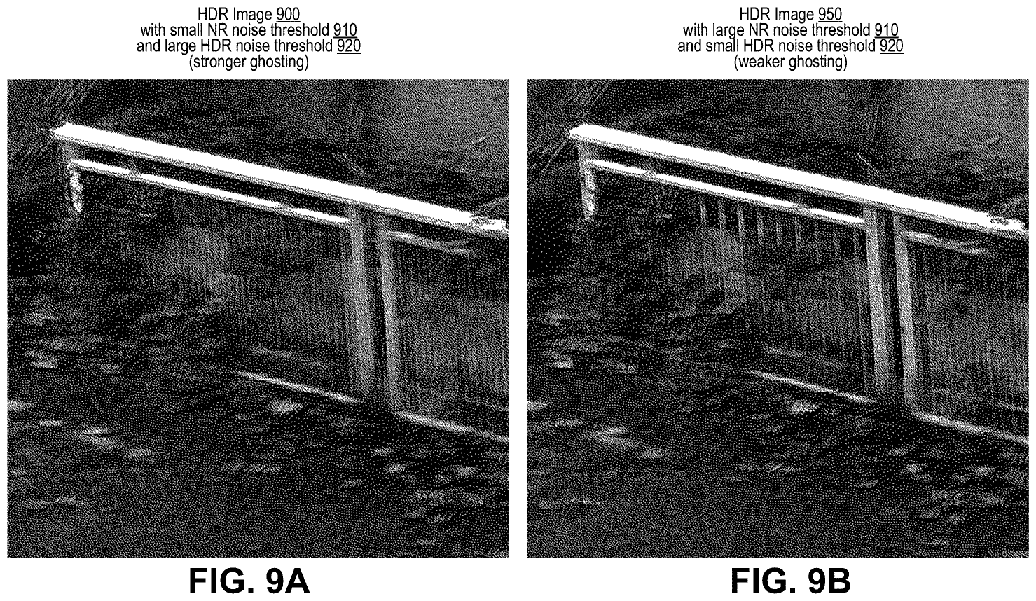

Further adjustment of NR and HDR can be achieved by adjusting the noise profile (e.g., noise threshold) values σ₁, σ₂, σ₃, and/or σ₄. Examples of differences in HDR images that can be achieved by adjusting the noise profile (e.g., noise threshold) values σ₁, σ₂, σ₃, and/or σ₄ are illustrated in FIGS. 9A-9B.

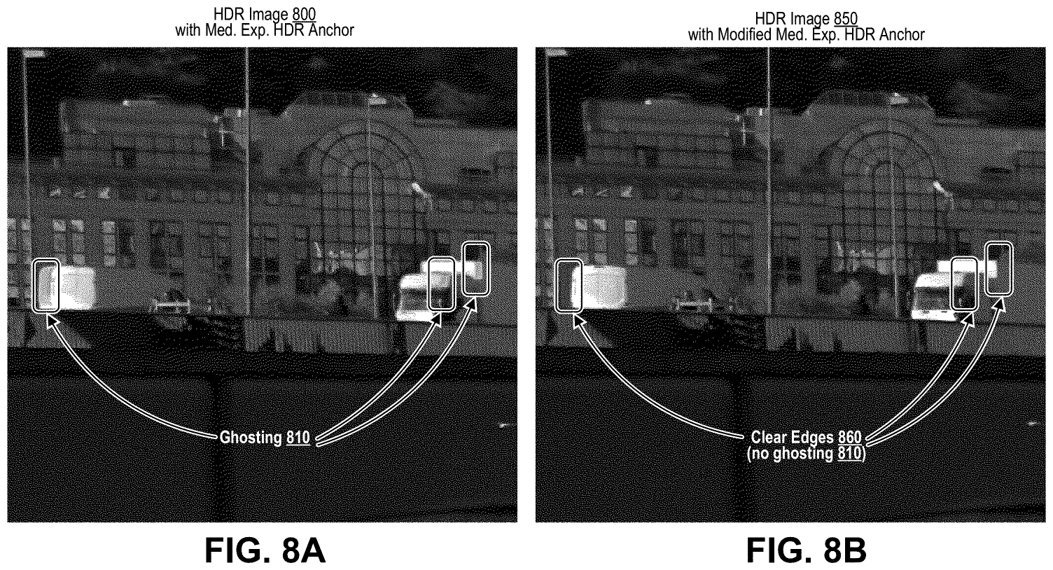

FIG. 8A is a conceptual diagram illustrating a high dynamic range (HDR) image 800 of a scene that includes ghosting 810 visual artifacts along certain edges of moving objects. The scene depicts two vehicles driving along a roadway. The two vehicles are in motion (e.g., and thus represent areas in motion 625). The roadway itself is blocked from view by a barrier in the foreground. The barrier is also in front of the vehicles. The vehicles are in front of a building that is in the background of the scene. The barrier and building are static (e.g., and thus represent areas that are static 620).

Certain edges of the vehicles are circled in FIG. 8A and include ghosting 810. The ghosting 810 of these edges appears to “extend” the width of the edges into grey blocks based on the direction and speed of the motion of the vehicles.

The HDR image 800 is an example of an HDR image 745 is produced without the use of a modified image such as the modified image 755. For instance, the HDR anchor of the MFHDR merge 740 for the HDR image 800 can be a medium exposure image, such as any of the medium exposure images 715A-715C, the noise-reduced medium exposure image 735, the medium exposure image 425, the medium exposure image 320, or any of the medium exposure images 210A-210C.

FIG. 8B is a conceptual diagram illustrating a high dynamic range (HDR) image 850 of the scene of FIG. 8A that includes clear edges 860 of moving objects without ghosting 810 visual artifacts due to the use of a modified image in generating the HDR image. The same edges of the vehicles in the HDR image 850 of FIG. 8B are circled as in the HDR image 800 of FIG. 8A. In the HDR image 850 of FIG. 8B, all of these edges appear as clear edges 860 with no ghosting 810 (no grey blocks extending the width of the edges).

The HDR image 850 is an example of an HDR image 765 is produced using of a modified image such as the modified image 755. For instance, the HDR anchor of the MFHDR merge 740 for the HDR image 850 can be a modified medium exposure image, such as the modified image 755 or the noise-reduced modified medium exposure image 760.

FIG. 9A is a conceptual diagram illustrating a high dynamic range (HDR) image 900 of a scene generated using a small noise reduction (NR) noise threshold 910 and a large HDR noise threshold 920. In particular, the HDR image 900 includes a small NR noise threshold. The scene depicted in FIG. 9A illustrates a metal fence with thin vertical slats as well as thicker vertical and horizontal slats. The scene also includes plants and soil around the fence.

FIG. 9B is a conceptual diagram illustrating a high dynamic range (HDR) image 950 of the scene of FIG. 9A generated using a large noise reduction (NR) noise threshold 910 and a small HDR noise threshold 920. The image processor 435 can adjust NR and HDR by adjusting the noise profile (e.g., noise threshold) values σ₁, σ₂, σ₃, and/or σ₄. For example, the HDR image 900 of FIG. 9A is generated using small noise reduction (NR) noise threshold 910 (σ₁) and a large HDR noise threshold 920 (σ₄). The HDR image 950 of FIG. 9B is generated using large noise reduction (NR) noise threshold 910 (σ₁) and a small HDR noise threshold 920 (σ₄).

As a result, the modified image I_{P} used to generate the HDR image 900 of FIG. 9A is noisier than the modified image I_{P} used to generate the HDR image 950 of FIG. 9B. Motion detection during MFHDR merging 740 Ψ_{σ}_{₄} used to generate the HDR image 900 of FIG. 9A is weaker than motion detection during MFHDR merging 740 Ψ_{σ}_{₄} used to generate the HDR image 950 of FIG. 9B. Ghosting is stronger in the HDR image 900 of FIG. 9A than in the HDR image 950 of FIG. 9B. For example, the vertical slats of the fence—both thick and thin—appear somewhat blurry and ghosted in the HDR image 900 of FIG. 9A, but appear clear in the HDR image 950 of FIG. 9B.

In some examples, the HDR image 900 may be produced under a MFNR noise profile σ₁ of (100-25-25-25) and a MFHDR noise profile σ₄ of (5-10-25-25). In some examples, the HDR image 950 may be produced under a MFNR noise profile σ₁ of (25-25-25-25) and a MFHDR noise profile σ₄ of (25-25-25-25).

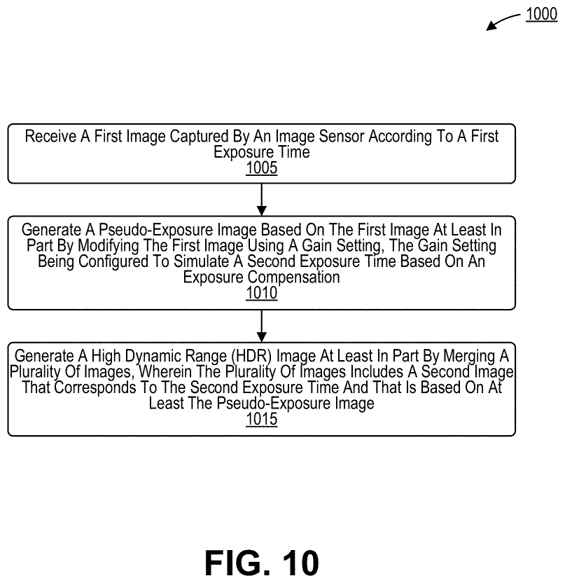

FIG. 10 is a flow diagram illustrating operations for image processing. The process 1000 may be performed by an imaging system. In some examples, the imaging system can include, for example, the image capture and processing system 100, the image capture device 105A, the image processing device 105B, the image processor 150, the ISP 154, the host processor 152, the imaging system 400, the imaging system 490, the imaging system of FIG. 7A, the imaging system of FIG. 7B, the computing system 1100, the processor 1110, or a combination thereof.

At operation 1005, the imaging system is configured to, and can, receive a first image captured by an image sensor according to a first exposure time. In some examples, the imaging system may include a connector coupled to the image sensor, and the image may be received using the connector. The connector may include a port, a jack, a wire, an input/output (IO) pin, a conductive trace on a printed circuit board (PCB), any other type of connector discussed herein, or some combination thereof. In some examples, the imaging system may include the image sensor. Examples of the image sensor include the image sensor 130, the image sensor(s) 415, the image sensor(s) 702, or a combination thereof.

At operation 1010, the imaging system is configured to, and can, generate a modified image based on the first image at least in part by modifying the first image using a gain setting. The gain setting is configured to simulate a second exposure time based on an exposure compensation. An example of the modified image is the modified image 755. With respect to FIG. 7B and the modified image 755, an example of the first image may be the short exposure image 710C. With respect to FIG. 7B and the modified image 755, an example of the first exposure time may be the short exposure time associated with the short exposure images 710A-710C. With respect to FIG. 7B and the modified image 755, an example of the second exposure time may be the medium exposure time associated with the medium exposure images 715A-715C.

In some aspects, the second exposure time is longer than the first exposure time. For instance, in the context of FIG. 7B, the first exposure time may be the short exposure time associated with the short exposure images 710A-710C and the second exposure time may be the medium exposure time associated with the medium exposure images. The medium exposure time may be longer than the short exposure time.

In some aspects, the second exposure time is shorter than the first exposure time for instance, the gain controller 752 may darken a longer exposure image to simulate a shorter exposure image.

At operation 1015, the imaging system is configured to, and can, generate a high dynamic range (HDR) image at least in part by merging a plurality of images. The plurality of images includes a second image that corresponds to the second exposure time and that is based on at least the modified image. Examples of the HDR image include the HDR image 230, the HDR image 340, the HDR image 450, the HDR image 510, the HDR image 745, the HDR image 765, the HDR image 800, the HDR image 850, the HDR image 900, the HDR image 950, or a combination thereof. Examples of the plurality of image include, for example, the long exposure image 205, the medium exposure images 210A-210C, the short exposure images 215A-215B, the short exposure image 310, the medium exposure image 320, the long exposure image 330, the short exposure image 420, the medium exposure image 425, the long exposure image 430, the first exposure images 492A-492C, the noise-reduced image 499, the long exposure images 705A-705C, the short exposure images 710A-710C, the medium exposure images 715A-715C, the noise-reduced long exposure image 725, the noise-reduced short exposure image 730, the noise-reduced medium exposure image 735, the modified image 755, the noise-reduced modified medium exposure image 760, or a combination thereof. Examples of merging the plurality of images to generate the HDR image include the HDR fusion engine 220, the fusion map 315, the fusion map 325, the fusion map 335, the image processor 435, the HDR fusion engine 440, the tone mapping engine 445, the multi-frame HDR merge 740, or a combination thereof.

In some aspects, the second image can be the modified image. For example, in the context of FIG. 7B, the modified image 755 can be one of the images that are merged using the multi-frame HDR merge 740 into the HDR image 765.

In some aspects, the imaging system can receive a third image captured by the image sensor according to the second exposure time, and the second image can be based on at least the modified image and the third image. For instance, the imaging device can generate the second image at least in part by performing noise reduction on the modified image based on at least the third image. Examples of the noise reduction include the noise reduction engine 495 and the multi-frame noise reduction 720. In the context of FIG. 7B, the third image can be one of the medium exposure images 715A-715C, and the second image can be the noise-reduced modified medium exposure image 760.

In some aspects, the plurality of images includes the first image. For example, in the context of FIG. 7B, the first image can be the short exposure image 710C, and the short exposure image 710C can be one of the images that are merged using the multi-frame HDR merge 740 into the HDR image 765.

In some aspects, the imaging system can receive a fourth image captured by the image sensor according to the first exposure time. The plurality of images can include a fifth image that corresponds to the first exposure time and that is based on at least the first image and the fourth image. The imaging system can generate the fifth image at least in part by performing noise reduction using at least the first image and the third image. Examples of the noise reduction include the noise reduction engine 495 and the multi-frame noise reduction 720. In the context of FIG. 7B, the fourth image can be one of the other short exposure images 710A-710B (other than the short exposure image 710C, which is the first image in this example), and the fifth image can be the noise-reduced modified short exposure image 730.

In some aspects, the imaging system receives a sixth image captured by the image sensor according to a third exposure time. In the context of FIG. 7B, the sixth image can be one of the long exposure images 705A-705C, and the third exposure time can be the long exposure time associated with the long exposure images 705A-705C. In some aspects, the plurality of images includes the sixth image. For example, in the context of FIG. 7B, the sixth image can be one of the long exposure images 705A-705C, and that one of the long exposure images 705A-705C can be one of the images that are merged using the multi-frame HDR merge 740 into the HDR image 765.

In some aspects, the imaging system receives the sixth image and a seventh image both captured by the image sensor according to the third exposure time. In the context of FIG. 7B, the sixth image and seventh image can be two of the long exposure images 705A-705C, and the third exposure time can be the long exposure time associated with the long exposure images 705A-705C. The plurality of images includes an eighth image that corresponds to the third exposure time and that is based on at least the sixth image and the seventh image. For instance, the imaging system can generate the eighth image at least in part by performing noise reduction using at least the sixth image and the seventh image. Examples of the noise reduction include the noise reduction engine 495 and the multi-frame noise reduction 720. In the context of FIG. 7B, the sixth image and seventh image can be two of the long exposure images 705A-705C, and the eighth image can be the noise-reduced modified long exposure image 725.

In some aspects, the third exposure time is longer than the first exposure time and the second exposure time. For instance, the context of FIG. 7B, the first exposure time may be the short exposure time associated with the short exposure images 710A-710C, the second exposure time may be the medium exposure time associated with the medium exposure images, and the third exposure time may be the long exposure time associated with the long exposure images 705A-705C. The long exposure time may be longer than the short exposure time and the medium exposure time.

In some aspects, the third exposure time is shorter than the first exposure time and the second exposure time. For instance, in the context of FIG. 7B, the first exposure time may be the short exposure time associated with the short exposure images 710A-710C, the second exposure time may be the medium exposure time associated with the medium exposure images, and the third exposure time may be a very short exposure time associated with one or more very short exposure images (not pictured) that are also merged into the HDR image 765, either on their own or after first merging into a noise-reduced very short exposure image using multi-frame noise reduction 720. The very short exposure time may be shorter than the short exposure time and the medium exposure time.

In some aspects, the third exposure time is between than the first exposure time and the second exposure time. In some examples, the third exposure time can be longer than the first exposure time, but shorter than the second exposure time. In some examples, the third exposure time can be longer than the second exposure time, but shorter than the first exposure time. For instance, in the context of FIG. 7B, the first exposure time may be the short exposure time associated with the short exposure images 710A-710C, the second exposure time may be the medium exposure time associated with the medium exposure images, and the third exposure time may be a slightly short exposure time associated with one or more slightly short exposure images (not pictured) that are also merged into the HDR image 765, either on their own or after first merging into a noise-reduced slightly short exposure image using multi-frame noise reduction 720. The slightly short exposure time may be between the short exposure time and the medium exposure time. For instance, the slightly short exposure time may be longer than the short exposure time but shorter than the medium exposure time.

In some aspects, the imaging system can output the HDR image. In some aspects, the imaging system can include a display. To output the HDR image, the imaging system can display the HDR image using the display. In some aspects, the imaging system includes a communication transceiver. To output the HDR image, the imaging system can send the HDR image to a recipient device using the communication transceiver. The recipient device can be a computing system 1100. In some examples, the recipient device can include a communication transceiver through which the recipient device can receive the HDR image. In some examples, the recipient device can include a display. The recipient device can display the HDR device on the display.

In some aspects, the imaging system can include: means for receiving a first image captured by an image sensor according to a first exposure time; means for generating a modified image based on the first image at least in part by modifying the first image using a gain setting, the gain setting being configured to simulate a second exposure time based on an exposure compensation; and/or means for generating a high dynamic range (HDR) image at least in part by merging a plurality of images, wherein the plurality of images includes a second image that corresponds to the second exposure time and that is based on at least the modified image. In some examples, the means for receiving the first image include the image sensor 130, the image capture device 105A, the image processing device 105B, the image capture and processing system 100. In some examples, the means for generating the modified image include the ISP 154, the host processor 152, the image processor 150, the tone mapping engine 445, the image processor 435, the gain controller 752, the processor 1110, or a combination thereof. In some examples, the means for generating the HDR image include the ISP 154, the host processor 152, the image processor 150, HDR fusion engine 220, the fusion map 315, the fusion map 325, the fusion map 335, the image processor 435, the HDR fusion engine 440, the tone mapping engine 445, the multi-frame HDR merge 740, the processor 1110, or a combination thereof.

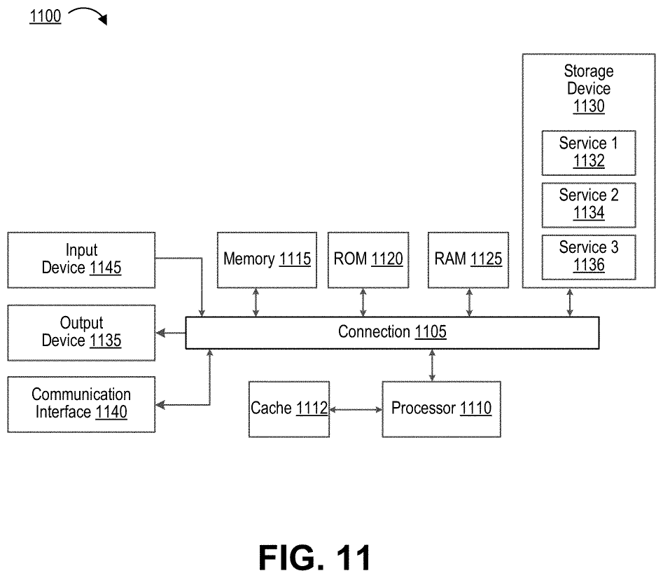

In some examples, the processes described herein (e.g., processes 200, 300, 400, 490, 700, 750, 1000 and/or other process described herein) may be performed by a computing device or apparatus. In some examples, the processes 200, 300, 400, 490, 700, 750, and/or 1000 can be performed by the imaging system 400, the imaging system 490, the imaging system of FIG. 7A, the imaging system of FIG. 7B, or a combination thereof. In another example, the processes 200, 300, 400, 490, 700, 750, and/or 1000 can be performed by a computing device with the computing system 1100 shown in FIG. 11.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the processes 200, 300, 400, 490, 700, 750, and/or 1000. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 200, 300, 400, 490, 700, 750, and/or 1000 is illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 200, 300, 400, 490, 700, 750, 1000 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1: An apparatus for processing image data, the apparatus comprising: a memory; and one or more processors coupled to the memory, the one or more processors configured to: receive a first image captured by an image sensor according to a first exposure time; generate a modified image based on the first image at least in part by modifying the first image using a gain setting, the gain setting being configured to simulate a second exposure time based on an exposure compensation; and generate a high dynamic range (HDR) image at least in part by merging a plurality of images, wherein the plurality of images includes a second image that corresponds to the second exposure time and that is based on at least the modified image.

Aspect 2. The apparatus of Aspect 1, wherein the second image is the modified image.

Aspect 3. The apparatus of any of Aspects 1 to 2, wherein the one or more processors are configured to: receive a third image captured by the image sensor according to the second exposure time, wherein the second image is based on at least the modified image and the third image.

Aspect 4. The apparatus of Aspect 3, wherein the one or more processors are configured to: generate the second image at least in part by performing noise reduction on the modified image based on at least the third image.

Aspect 5. The apparatus of any of Aspects 1 to 4, wherein the plurality of images includes the first image.

Aspect 6. The apparatus of any of Aspects 1 to 5, wherein the one or more processors are configured to: receive a third image captured by the image sensor according to the first exposure time, wherein the plurality of images includes a fourth image that corresponds to the first exposure time and that is based on at least the first image and the third image.

Aspect 7. The apparatus of Aspect 7, wherein the one or more processors are configured to: generate the fourth image at least in part by performing noise reduction using at least the first image and the third image.

Aspect 8. The apparatus of any of Aspects 1 to 7, wherein the one or more processors are configured to: receive a third image captured by the image sensor according to a third exposure time, wherein the plurality of images includes the third image.

Aspect 9. The apparatus of any of Aspects 1 to 8, wherein the one or more processors are configured to: receive a third image and a fourth image both captured by the image sensor according to a third exposure time, wherein the plurality of images includes a fifth image that corresponds to the third exposure time and that is based on at least the third image and the fourth image.

Aspect 10. The apparatus of Aspect 9, wherein the one or more processors are configured to: generate the fifth image at least in part by performing noise reduction using at least the third image and the fourth image.

Aspect 11. The apparatus of any of Aspects 9 to 10, wherein the third exposure time is shorter than the first exposure time and the second exposure time.

Aspect 12. The apparatus of any of Aspects 9 to 11, wherein the third exposure time is longer than the first exposure time and the second exposure time.

Aspect 13. The apparatus of any of Aspects 9 to 12, wherein the third exposure time is between than the first exposure time and the second exposure time.

Aspect 14. The apparatus of any of Aspects 1 to 13, wherein the second exposure time is longer than the first exposure time.

Aspect 15. The apparatus of any of Aspects 1 to 14, wherein the second exposure time is shorter than the first exposure time.

Aspect 16. The apparatus of any of Aspects 1 to 15, wherein the one or more processors are configured to: output the HDR image.

Aspect 17. The apparatus of Aspect 16, further comprising: a display, wherein, to output the HDR image, the one or more processors are configured to display the HDR image using the display.

Aspect 18. The apparatus of any of Aspects 16 to 17, further comprising: a communication transceiver, wherein, to output the HDR image, the one or more processors are configured to send the HDR image to a recipient device using the communication transceiver.

Aspect 19. The apparatus of any of Aspects 1 to 18, further comprising: the image sensor.

Aspect 20. The apparatus of any of Aspects 1 to 19, wherein the apparatus includes at least one of a mobile handset, a wireless communication device, and a head-mounted display.

Aspect 21. A method of processing image data, the method comprising: receiving a first image captured by an image sensor according to a first exposure time; generating a modified image based on the first image at least in part by modifying the first image using a gain setting, the gain setting being configured to simulate a second exposure time based on an exposure compensation; and generating a high dynamic range (HDR) image at least in part by merging a plurality of images, wherein the plurality of images includes a second image that corresponds to the second exposure time and that is based on at least the modified image.

Aspect 22. The method of Aspect 21, wherein the second image is the modified image.

Aspect 23. The method of any of Aspects 21 to 22, further comprising: receiving a third image captured by the image sensor according to the second exposure time, wherein the second image is based on at least the modified image and the third image.

Aspect 24. The method of Aspect 23, further comprising: generating the second image at least in part by performing noise reduction on the modified image based on at least the third image.

Aspect 25. The method of any of Aspects 21 to 24, wherein the plurality of images includes the first image.

Aspect 26. The method of any of Aspects 21 to 25, further comprising: receiving a third image captured by the image sensor according to the first exposure time, wherein the plurality of images includes a fourth image that corresponds to the first exposure time and that is based on at least the first image and the third image.

Aspect 27. The method of Aspect 26, further comprising: generating the fourth image at least in part by performing noise reduction using at least the first image and the third image.

Aspect 28. The method of any of Aspects 21 to 27, further comprising: receiving a third image captured by the image sensor according to a third exposure time, wherein the plurality of images includes the third image.

Aspect 29. The method of any of Aspects 21 to 28, further comprising: receiving a third image and a fourth image both captured by the image sensor according to a third exposure time, wherein the plurality of images includes a fifth image that corresponds to the third exposure time and that is based on at least the third image and the fourth image.

Aspect 30. The method of Aspect 29, further comprising: generating the fifth image at least in part by performing noise reduction using at least the third image and the fourth image.

Aspect 31. The method of any of Aspects 29 to 30, wherein the third exposure time is shorter than the first exposure time and the second exposure time.

Aspect 32. The method of any of Aspects 29 to 31, wherein the third exposure time is longer than the first exposure time and the second exposure time.

Aspect 33. The method of any of Aspects 29 to 32, wherein the third exposure time is between than the first exposure time and the second exposure time.

Aspect 34. The method of any of Aspects 21 to 33, wherein the second exposure time is longer than the first exposure time.

Aspect 35. The method of any of Aspects 21 to 34, wherein the second exposure time is shorter than the first exposure time.

Aspect 36. The method of any of Aspects 21 to 35, further comprising: outputting the HDR image.

Aspect 37. The method of Aspect 36, wherein outputting the HDR image includes displaying the HDR image using a display.

Aspect 38. The method of any of Aspects 36 to 37, wherein outputting the HDR image includes sending the HDR image to a recipient device using a communication transceiver.

Aspect 39. The method of any of Aspects 21 to 38, wherein the method is performed by a device that includes the image sensor.

Aspect 40. The method of any of Aspects 21 to 39, wherein the method is performed by at least one of a mobile handset, a wireless communication device, and a head-mounted display.

Aspect 41: A non-transitory computer-readable medium having stored thereon instructions that, when executed by one or more processors, cause the one or more processors to: receive a first image captured by an image sensor according to a first exposure time; generate a modified image based on the first image at least in part by modifying the first image using a gain setting, the gain setting being configured to simulate a second exposure time based on an exposure compensation; and generate a high dynamic range (HDR) image at least in part by merging a plurality of images, wherein the plurality of images includes a second image that corresponds to the second exposure time and that is based on at least the modified image.

Aspect 42: The non-transitory computer-readable medium of Aspect 41, further comprising any of Aspects 2 to 39, and/or any of Aspects 22 to 40.

Aspect 43: An apparatus for image processing, the apparatus comprising: means for receiving a first image captured by an image sensor according to a first exposure time; means for generating a modified image based on the first image at least in part by modifying the first image using a gain setting, the gain setting being configured to simulate a second exposure time based on an exposure compensation; and means for generating a high dynamic range (HDR) image at least in part by merging a plurality of images, wherein the plurality of images includes a second image that corresponds to the second exposure time and that is based on at least the modified image.

Aspect 44: The apparatus of Aspect 43, further comprising any of Aspects 2 to 39, and/or any of Aspects 22 to 40.

What is claimed is:

1. An apparatus for processing image data, the apparatus comprising:
a memory; and
one or more processors coupled to the memory, the one or more processors configured to:
receive a first image captured by an image sensor according to a first exposure time;
generate a modified image based on the first image at least in part by modifying the first image using a gain setting, the gain setting being configured to simulate a second exposure time based on an exposure compensation; and
generate a high dynamic range (HDR) image at least in part by merging a plurality of images, wherein the plurality of images includes a second image that corresponds to the second exposure time and that is based on at least the modified image.

2. The apparatus of claim 1, wherein the second image is the modified image.

3. The apparatus of claim 1, wherein the one or more processors are configured to:
receive a third image captured by the image sensor according to the second exposure time, wherein the second image is based on at least the modified image and the third image.

4. The apparatus of claim 3, wherein the one or more processors are configured to:
generate the second image at least in part by performing noise reduction on the modified image based on at least the third image.

5. The apparatus of claim 1, wherein the plurality of images includes the first image.

6. The apparatus of claim 1, wherein the one or more processors are configured to:
receive a third image captured by the image sensor according to the first exposure time, wherein the plurality of images includes a fourth image that corresponds to the first exposure time and that is based on at least the first image and the third image.

7. The apparatus of claim 6, wherein the one or more processors are configured to:
generate the fourth image at least in part by performing noise reduction using at least the first image and the third image.

8. The apparatus of claim 1, wherein the one or more processors are configured to:
receive a third image captured by the image sensor according to a third exposure time, wherein the plurality of images includes the third image.

9. The apparatus of claim 1, wherein the one or more processors are configured to:
receive a third image and a fourth image both captured by the image sensor according to a third exposure time, wherein the plurality of images includes a fifth image that corresponds to the third exposure time and that is based on at least the third image and the fourth image.

10. The apparatus of claim 9, wherein the one or more processors are configured to:
generate the fifth image at least in part by performing noise reduction using at least the third image and the fourth image.

11. The apparatus of claim 9, wherein the third exposure time is shorter than the first exposure time and the second exposure time.

12. The apparatus of claim 9, wherein the third exposure time is longer than the first exposure time and the second exposure time.

13. The apparatus of claim 9, wherein the third exposure time is between than the first exposure time and the second exposure time.

14. The apparatus of claim 1, wherein the second exposure time is longer than the first exposure time.

15. The apparatus of claim 1, wherein the second exposure time is shorter than the first exposure time.

16. The apparatus of claim 1, wherein the one or more processors are configured to:
output the HDR image.

17. The apparatus of claim 16, further comprising:
a display, wherein, to output the HDR image, the one or more processors are configured to display the HDR image using the display.

18. The apparatus of claim 16, further comprising:
a communication transceiver, wherein, to output the HDR image, the one or more processors are configured to send the HDR image to a recipient device using the communication transceiver.

19. The apparatus of claim 1, further comprising:
the image sensor.

20. The apparatus of claim 1, wherein the apparatus includes at least one of a mobile handset, a wireless communication device, and a head-mounted display.

21. A method of processing image data, the method comprising:
receiving a first image captured by an image sensor according to a first exposure time;
generating a modified image based on the first image at least in part by modifying the first image using a gain setting, the gain setting being configured to simulate a second exposure time based on an exposure compensation; and
generating a high dynamic range (HDR) image at least in part by merging a plurality of images, wherein the plurality of images includes a second image that corresponds to the second exposure time and that is based on at least the modified image.

22. The method of claim 21, wherein the second image is the modified image.

23. The method of claim 21, further comprising:
receiving a third image captured by the image sensor according to the second exposure time, wherein the second image is based on at least the modified image and the third image.

24. The method of claim 21, wherein the plurality of images includes the first image.

25. The method of claim 21, further comprising:
receiving a third image captured by the image sensor according to the first exposure time, wherein the plurality of images includes a fourth image that corresponds to the first exposure time and that is based on at least the first image and the third image.

26. The method of claim 21, further comprising:
receiving a third image captured by the image sensor according to a third exposure time, wherein the plurality of images includes the third image.

27. The method of claim 21, further comprising:
receiving a third image and a fourth image both captured by the image sensor according to a third exposure time, wherein the plurality of images includes a fifth image that corresponds to the third exposure time and that is based on at least the third image and the fourth image.

28. The method of claim 21, wherein the second exposure time is longer than the first exposure time.

29. The method of claim 21, wherein the second exposure time is shorter than the first exposure time.

30. The method of claim 21, further comprising:
outputting the HDR image.
